(19) United States
(12) Patent Application Publication
(10) Pub. No.: US 2014/0035928 A1
(43) Pub. Date: Feb. 6, 2014

(54) IMAGE DISPLAY APPARATUS

(71) Applicant: Mitsuru OHGAKE, Chiba (JP)

(72) Inventor: Mitsuru OHGAKE, Chiba (JP)

(21) Appl. No.: 13/913,605

(22) Filed: Jun. 10, 2013

(30) Foreign Application Priority Data
Jul. 31, 2012 (JP) 2012-169814

(51) Int. Cl. G09G 5/24

(52) U.S. Cl. CPC G09G 5/24
USPC 345/467

(57) ABSTRACT

An image display apparatus includes an image display device, a language recognition device, and a text information display device. The image display device displays an image on a display screen. The language recognition device recognizes, on the basis of an image signal of an input image displayed on the display screen, the language of a text portion included in the input image. The text information display device displays text information on the display screen using the language recognized by the language recognition device.

### CROSS-REFERENCE TO RELATED APPLICATIONS

This patent application is based on and claims priority pursuant to 35 U.S.C. §119 to Japanese Patent Application No. 2012-169814, filed on Jul. 31, 2012, in the Japan Patent Office, the entire disclosure of which is hereby incorporated by reference herein.

### BACKGROUND

1. Technical Field

The present invention relates to an image display apparatus such as an image projection apparatus.

2. Related Art

When an image display apparatus is first used, a variety of settings are performed by a user from a menu or message displayed in a preset language. These settings include, for example, settings for image adjustments such as contrast and brightness, display settings such as the settings of the display language and the image size, and the settings of the installation state, a fan, and a network. The language of the menu or message displayed by the image display apparatus may be preset for the country of use or the shipping destination, or may be set by a user from a menu or message displayed when the image display apparatus is first powered up. The language may also be set or changed by a user through the menu or the like at a time other than the first power-up. Such a function of the image display apparatus to display a settings screen for various operations is called on-screen display (OSD).

If an incorrect language is accidentally set by a user in the settings following the first power-up, or if there is a change of user or a change of country of use of the image display apparatus, however, the menu or message may be displayed in a language incomprehensible to the user. In such a case, the user may have difficulty in performing or changing the settings of the image display apparatus and feel uncomfortable using the image display apparatus.

The language for displaying the menu or the like of the image display apparatus may be set not only by the user with the above-described OSD but also by a technique of identifying the country of use on the basis of an input power supply voltage or positional information based on the global positioning system (GPS) and setting the display language on the basis of the information of the identified country of use.

For example, the image display apparatus may be configured to select a predetermined display element group from a plurality of display element groups on the basis of a detection result of a power supply information detector that detects the information of the input power supply voltage, and thereby select and display a language according to conditions such as country.

In such an image display apparatus, however, it is difficult to narrow down possible countries of use to one country due to the lack of a significant difference in power supply voltage between the countries of use. As a result, the user is usually asked to select the country of use from a plurality of countries in which the detected input power supply voltage is used. In this case, if the user accidentally selects an incorrect country of use, the menu or message may be displayed in a language incomprehensible to the user. Consequently, the user may have difficulty in resetting or correcting the language of displayed text and feel uncomfortable using the image display apparatus. Further, even if the language has been set in accordance with the country of use, a user from a different country may have difficulty in understanding the displayed text information.

In addition, if the image display apparatus is configured to set the language of the displayed text on the basis of the above-described positional information from the GPS, it is difficult for the image display apparatus, which is usually used indoor, to receive radio waves from the GPS and automatically set the optimal language. Further, similarly as in the configuration using the information of the input power supply voltage, even if the language has been set in accordance with the country of use, a user from a different country may have difficulty in understanding the displayed text.

### SUMMARY

The present invention provides a novel image display apparatus that, in one example, includes an image display device, a language recognition device, and a text information display device. The image display device displays an image on a display screen. The language recognition device recognizes, on the basis of an image signal of an input image displayed on the display screen, the language of a text portion included in the input image. The text information display device displays text information on the display screen using the language recognized by the language recognition device.

### BRIEF DESCRIPTION OF THE DRAWINGS

A more complete appreciation of the invention and many of the advantages thereof are obtained as the same becomes better understood by reference to the following detailed description when considered in connection with the accompanying drawings, wherein:

FIG. 1 is a functional block diagram illustrating a schematic configuration of an example of an image projection apparatus according to an embodiment of the present invention;

FIG. 2 is a diagram illustrating an example of a language data table stored in a language data storage unit;

FIG. 3 is a diagram illustrating an example of a recognized language table stored in a recognition result storage unit;

FIG. 4 is a flowchart illustrating an example of the procedure of a language setting process;

FIG. 5 is a flowchart illustrating an example of the procedure of a forced language setting process according to an instruction from a user;

FIG. 6 is a flowchart illustrating an example of the procedure of a recognized language setting process;

FIG. 7 is a flowchart illustrating an example of the procedure of a language recognition process;

FIG. 8 is a flowchart illustrating an example of the procedure of a language recognition process performed on text regions extracted as blocks;

FIG. 9 is a flowchart illustrating an example of the procedure of a recognized language table updating process;

FIG. 10 is a flowchart illustrating an example of the procedure of recognized language setting;

FIG. 11 is diagram illustrating an example of a message displayed when the recognized language is Japanese;

FIG. 12 is a diagram illustrating an example of a message displayed when the recognized languages are Japanese and two other languages; and

FIG. 13 is a diagram illustrating an example of a message displayed when the language for displaying text information has already been set and is attempted to be changed.

### DETAILED DESCRIPTION

In describing the embodiments illustrated in the drawings, specific terminology is adopted for the purpose of clarity. However, the disclosure of the present invention is not intended to be limited to the specific terminology so used, and it is to be understood that substitutions for each specific element can include any technical equivalents that have the same function, operate in a similar manner, and achieve a similar result.

Referring now to the drawings, wherein like reference numerals designate identical or corresponding parts throughout the several views, an image projection apparatus (i.e., projector) according to an embodiment of the present invention will be described as an image display apparatus according to an embodiment of the present invention. An image display apparatus according to an embodiment of the present invention is capable of reliably displaying text information in a language comprehensible to a user.

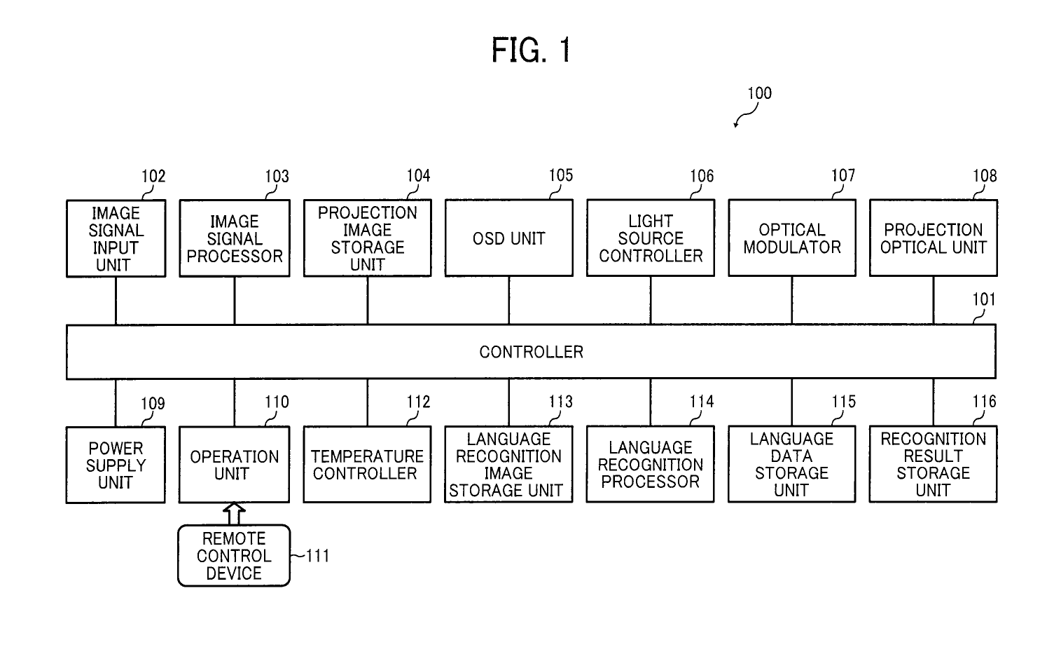

A basic configuration of the image projection apparatus according to the present embodiment will first be described. FIG. 1 is a functional block diagram illustrating a schematic configuration of an example of the image projection apparatus according to the present embodiment. In FIG. 1, an image projection apparatus 100 serving as an image display apparatus includes a controller 101, an image signal input unit 102, an image signal processor 103, a projection image storage unit 104, an on-screen display (OSD) unit 105, a light source controller 106, an optical modulator 107, a projection optical unit 108, a power supply unit 109, an operation unit 110, a remote control device 111, a temperature controller 112, a language recognition image storage unit 113, a language recognition processor 114, a language data storage unit 115, and a recognition result storage unit 116.

The controller 101 performs an overall control of the image projection apparatus 100. The controller 101 is a microcomputer including, for example, a central processing unit (CPU), a read only memory (ROM), and a random access memory (RAM) and capable of controlling the respective units by executing predetermined programs previously installed therein. The input image may be, for example, data for presentation. The externally input image signal may be, for example, an image data signal transmitted from an external apparatus such as a computer, a signal from a high-definition multimedia interface (HDMI), a composite video signal, or an image signal input from an external storage medium such as a universal serial bus (USB) memory or from a network.

The image signal input unit 102 receives an externally input image signal of an input image for display. The image signal processor 103 performs, for example, signal conversion, color correction, and distortion correction on the input image signal in accordance with the number of pixels and the frequency. The projection image storage unit 104 stores image data processed by the image signal processor 103 and the data of text information to be displayed by the OSD unit 105. The OSD unit 105 serves as a text information display device that has a function of displaying, on an external projection screen serving as a display screen, the image of text information of an operation settings menu, a message, an operating state, and so forth. The light source controller 106 controls a not-illustrated light source to output projection light.

The optical modulator 107 separates the projection light into three primary color components of red, green, and blue, and performs optical modulation on the respective color components in accordance with the image signal. The projection optical unit 108 projects a beam of optically modulated light onto a projection screen. The power supply unit 109 supplies power to the light source and other devices. The operation unit 110 processes operations performed on keys provided on the remote control device 111 and operations performed on keys provided on the body of the image projection apparatus 100. The operation unit 110 and the remote control device 111 cooperate to function as an operation device. The temperature controller 112 cools the light source and the interior of the image projection apparatus 100. The language recognition image storage unit 113 stores image data for language recognition. The language recognition processor 114 performs a language recognition process by analyzing the image data stored in the language recognition image storage unit 113. The language data storage unit 115 stores display character string data of various languages used when the OSD unit 105 displays the text information. The recognition result storage unit 116 stores the result of the language recognition process.

The image signal processor 103, the projection image storage unit 104, the light source controller 106, the optical modulator 107, and the projection optical unit 108 cooperate to function as an image display device that displays the image on the external projection screen (i.e., display screen). The language recognition image storage unit 113, the language recognition processor 114, the language data storage unit 115, and the recognition result storage unit 116 cooperate to function as a language recognition device that recognizes the language of text included in the input image on the basis of the image signal of the input image displayed on the display screen.

Each of the projection image storage unit 104, the language recognition image storage unit 113, the language data storage unit 115, and the recognition result storage unit 116 may be, for example, a semiconductor memory or a storage device such as a magnetic disc or an optical disc. Further, each of the processors such as the image signal processor 103 and the language recognition processor 114 may be, for example, a special semiconductor integrated circuit or a microcomputer capable of executing the above-described predetermined programs installed therein.

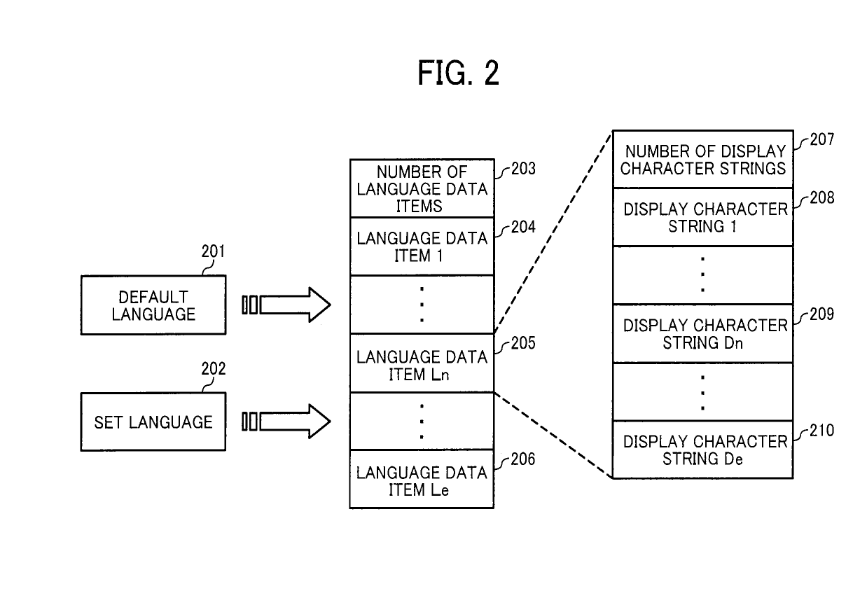

A description will now be given of an example of a language data table containing the display character string data of various languages stored in the language data storage unit 115. FIG. 2 is a diagram illustrating an example of the language data table stored in the language data storage unit 115. In FIG. 2, the language data table stored in the language data storage unit 115 includes a data region 201 for a default language, a data region 202 for a set language, a data region 203 for the number of language data items, and data regions 204 to 206 for language data items 1 to Le.

The data region 203 for the number of language data items stores the number of language data items 1 to Le in the data regions 204 to 206, which are displayable by the OSD unit 105. In the illustrated example, a value Le is stored in the data region 203.

Each of the data regions 204 to 206 for the language data items 1 to Le stores a plurality of display character string data items for the corresponding language usable to display the menu or message. For example, the data region 204 for the language data item 1 stores the data of display character strings of the menu or message to be displayed in Japanese, and the data region 206 for the language data item Le stores the data of display character strings of the menu or message to be displayed in English.

The data region 201 for the default language stores, as language identification information for specifying the default language, data for specifying one of the language data items 1 to Le in the data regions 204 to 206. For example, if no language is recognized by the language recognition process performed on the basis of the image signal of the input image, the default language is used in the display of the text information by the OSD unit 105, irrespective of the result of the language recognition process. If the country of use is Japan, the default language may be Japanese, or may be English, which is commonly used in the world. If the default language is Japanese, the data region 201 for the default language stores data for specifying the language data item corresponding to Japanese (e.g., the language data item 1 in the data region 204). If the default language is English, the data region 201 for the default language stores data for specifying the language data item corresponding to English (e.g., the language data item Le in the data region 206). The data region 202 for the set language stores, as language identification information indicating the language used in the display of the text information by the OSD unit 105, data for specifying one of the language data items 1 to Le in the data regions 204 to 206. For example, a value −1 is set in the data region 202 for the set language as an initial value. The initial value indicates that the OSD unit 105 displays the text information of the menu or message using the language specified by the data stored in the data region 201 for the default language. If the value set in the data region 202 for the set language is other than the initial value, the value is one of 1 to Le serving as language identification information for identifying the language of the corresponding one of the language data items 1 to Le in the data regions 204 to 206. The text information of the menu or message is displayed in the language corresponding to the value of the language identification information.

Each of the data regions 204 to 206 for the language data items 1 to Le includes a data region 207 for the number of display character strings and data regions 208 to 210 for display character strings 1 to De. The data region 207 for the number of display character strings stores, as the number of display character strings of the menu or message used in the display of the text information by the OSD unit 15, the number of display character strings 1 to De in the data regions 208 to 210. In the illustrated example, a value De is stored in the data region 207. For example, if the language corresponding to the language data item 1 in the data region 204 is Japanese, the data regions 208 to 210 for the display character strings 1 to De included in the data region 204 for the language data item 1 store display character strings of the menu or message written in Japanese. Further, if the language corresponding to the language data item Ln in the data region 205 is English, the data regions 208 to 210 for the display character strings 1 to De included in the data region 205 for the language data item Ln store display character strings of the menu or message written in English, which have the same meaning as the Japanese display character strings and are stored in the same order as the Japanese display character strings. For example, it is assumed that the language corresponding to the language data item 1 in the data region 204 is Japanese, and that a display character string SETUP MENU written in Japanese is stored in the data region 208 for the display character string 1 in the data region 204 for the language data item 1. In this case, the data region 208 for the display character string 1 in the data region 205 for the language data item Ln corresponding to English stores a display character string SETUP MENU written in English. The data regions 208 to 210 for the display character strings 1 to De thus store different text information items, i.e., different display characters or display character strings. Further, respective data regions 209 for a display character string Dn included in the language data items corresponding to the respective languages store respective text information items, i.e., display characters or display character strings written in the respective languages and expressing the same meaning. Therefore, each of the display character strings 1 to De in the data regions 208 to 210 designated by a given number is readily displayed as text information items of the same meaning written in the respective languages.

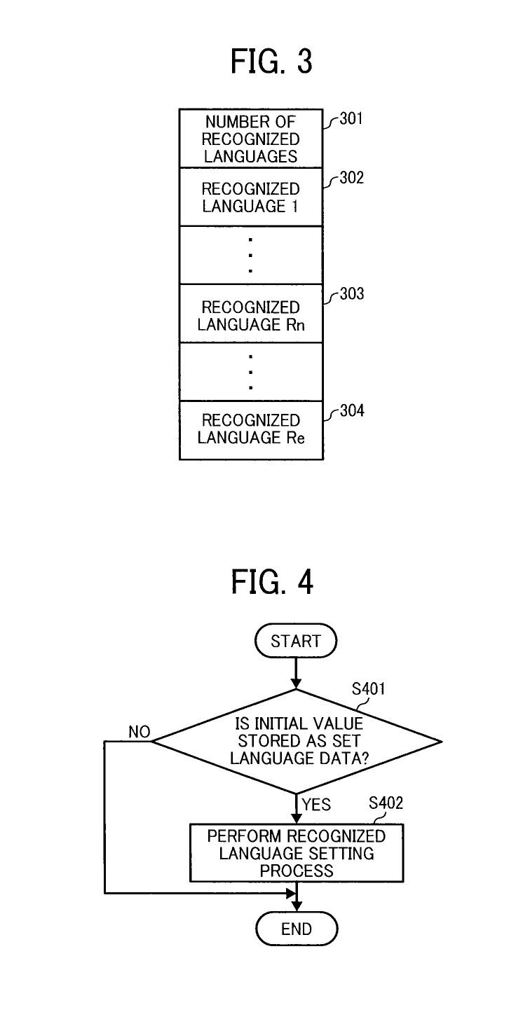

A recognized language table stored in the recognition result storage unit 116 will now be described. FIG. 3 is a diagram illustrating an example of the recognized language table stored in the recognition result storage unit 116. The recognition result storage unit 116 stores the result of the language recognition process. In the language recognition process, the language of the text included in the input image is recognized on the basis of the image signal (i.e., image data) of the input image for projection stored in the projection image storage unit 104. In FIG. 3, the recognized language table stored in the recognition result storage unit 116 includes a data region 301 for the number of recognized languages and data regions 302 to 304 for recognized languages 1 to Re. The value in the data region 301 for the number of recognized languages represents the number of languages of the text in the input image recognized on the basis of the image signal (i.e., image data) of the input image for projection. For example, if no language is recognized, a value 0 is stored in the data region 301 for the number of recognized languages. Further, if the Re number of languages are recognized, a value Re is stored in the data region 301 for the number of recognized languages. Herein, the number of languages recognizable by the image projection apparatus 100 of the present embodiment (i.e., the value set in the above-described data region 203 for the number of language data items) is Le. Thus, the value Re does not exceed the value Le.

Further, each of the data regions 302 to 304 for the recognized languages 1 to Re stores, as language identification information for identifying the recognized language, data representing one of the language data items 1 to Le in the data regions 204 to 206. For example, if Japanese is first recognized on the basis of the image signal (i.e., image data) of the input image for projection, and if the language data item 1 in the data region 204 illustrated in FIG. 2 corresponds to Japanese, a value 1 is stored in the data region 302 for the recognized language 1 as the language identification information, and a value 1 is stored in the data region 301 for the number of recognized languages. Further, if English is recognized in the Rn-th place on the basis of the image signal (i.e., image data) of the same input image, and if the language data item Ln in the data region 205 illustrated in FIG. 2 corresponds to English, a value Ln is stored in the data region 303 for the recognized language Rn as the language identification information, and a value Rn is stored in the data region 301 for the number of recognized languages.

A procedure of a language setting process will now be described. FIG. 4 is a flowchart illustrating an example of the procedure of the language setting process. In FIG. 4, determination is made on whether or not the data of the language identification information stored in the data region 202 for the set language is the initial value (e.g., −1) (step S401). If the data in the data region 202 for the set language is the initial value (YES at step S401), a recognized language setting process is performed which sets a language by recognizing the text included in the input image on the basis of the image signal (i.e., image data) input as the input image for projection (step S402). If the data in the data region 202 for the set language is not the initial value (NO at step S401), the language for use in the display of the text information has already been set. Therefore, the above-described recognized language setting process is not performed.

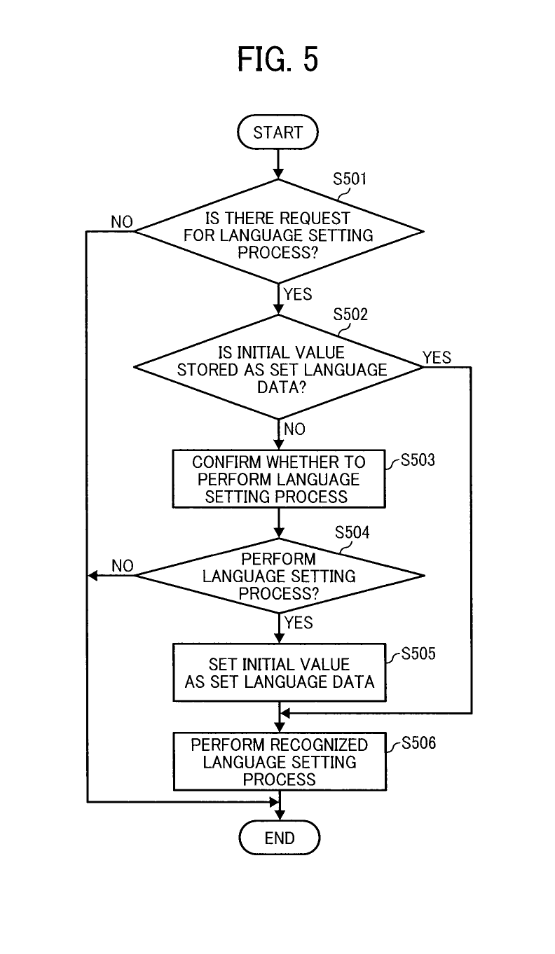

A procedure of a forced language setting process according to an instruction from a user will now be described. FIG. 5 is a flowchart illustrating an example of the procedure of the forced language setting process according to an instruction from a user. In FIG. 5, if a user sends a request for executing the forced language setting process by, for example, pressing a special key for the forced language setting process included in the operation unit 110 or concurrently pressing multiple predetermined keys for the forced language setting process included in the operation unit 110 (YES at step 501), determination is made on whether or not the language for use in the display of the text information has not been set, i.e., whether or not the data of the language identification information stored in the data region 202 for the set language is the initial value (e.g., −1) (step S502). If the data of the language identification information stored in the data region 202 for the set language is the initial value (e.g., −1) (YES at step S502), the recognized language setting process is performed which sets a language by recognizing the text included in the input image on the basis of the image signal (i.e., image data) input as the input image for projection (step S506). If the data in the data region 202 for the set language is not the initial value (NO at step S502), the language for use in the display of the text information has already been set. Therefore, the message illustrated in FIG. 13, for example, is displayed to confirm with the user whether or not to perform the language setting process (step S503). If the user selects NO in the message (NO at step S504), the language setting process is not performed. If the user selects YES in the message (YES at step S504), the initial value (e.g., −1) is set as the data of the language identification information in the data region 202 for the set language (step S505), and the above-described recognized language setting process is performed (step S506). The forced language setting process allows the language for use in the display of the text information to be changed in accordance with the instruction from the user.

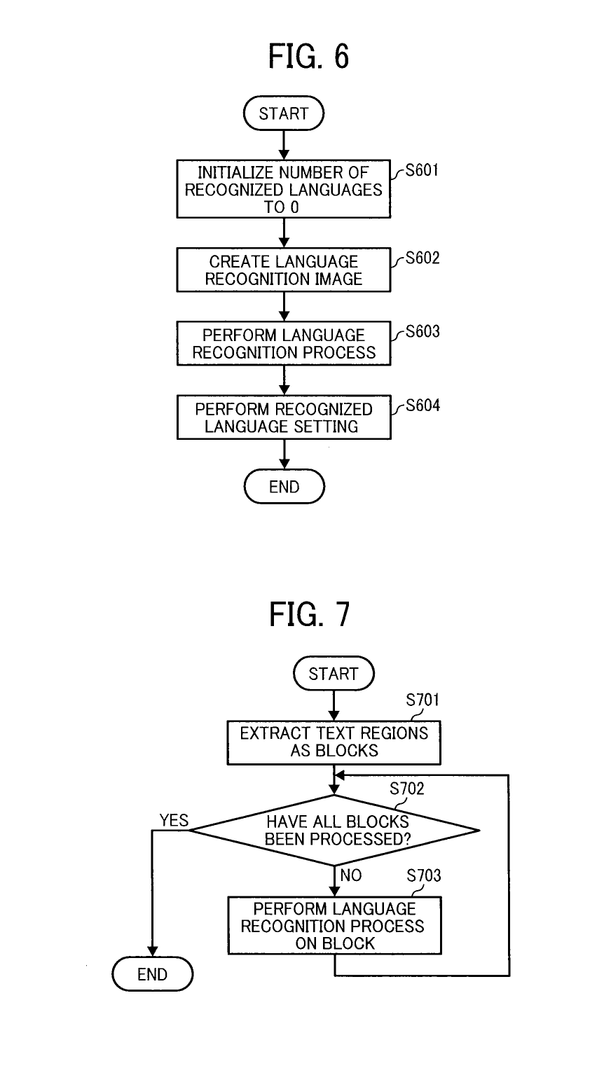

The recognized language setting process at step S402 of FIG. 4 and step S506 of FIG. 5 will now be described in detail. FIG. 6 is a flowchart illustrating an example of the procedure of the recognized language setting process. In FIG. 6, the value in the data region 301 for the number of recognized languages, which represents the result of the language recognition process, is initialized to a value 0 (step S601). Then, the image data of the input image for projection is read from the projection image storage unit 104, and a language recognition image for use in the language recognition process is created and stored in the language recognition image storage unit 113 (step S602). Thereafter, the language recognition process is performed on the language recognition image (step S603), and the recognized language setting is performed such that a language recognized by the language recognition process is used to display the text information (step S604).

The language recognition process at step S603 of FIG. 6 will now be described in detail. FIG. 7 is a flowchart illustrating an example of the procedure of the language recognition process at step S603. In FIG. 7, text regions are extracted as blocks from the language recognition image (step S701), and the language recognition process of recognizing the language in the text region is performed on each of the blocks (step S703), i.e., until the language recognition process is performed on all of the blocks (YES at step S702).

As an example of the method of extracting text from the input image on the basis of the image signal (i.e., image data) of the input image for projection, text characters may be extracted by portable document format (PDF; a registered trademark of Adobe Systems Incorporated) analysis, if the file of the input image input from an external storage medium such as a USB memory or from a network is a PDF file. Specifically, character codes in the data of the PDF file may be recognized, and thereby text characters may be extracted. Alternatively, characters may be recognized as graphic or image data from outline font or the like, and thereafter text characters may be extracted. Further, text characters may be extracted from the image data generated from the image signal in accordance with the optical character recognition (OCR) technique. Even if the text characters extracted by these methods are relatively low in extraction accuracy, the language of text characters is still relatively easily recognized.

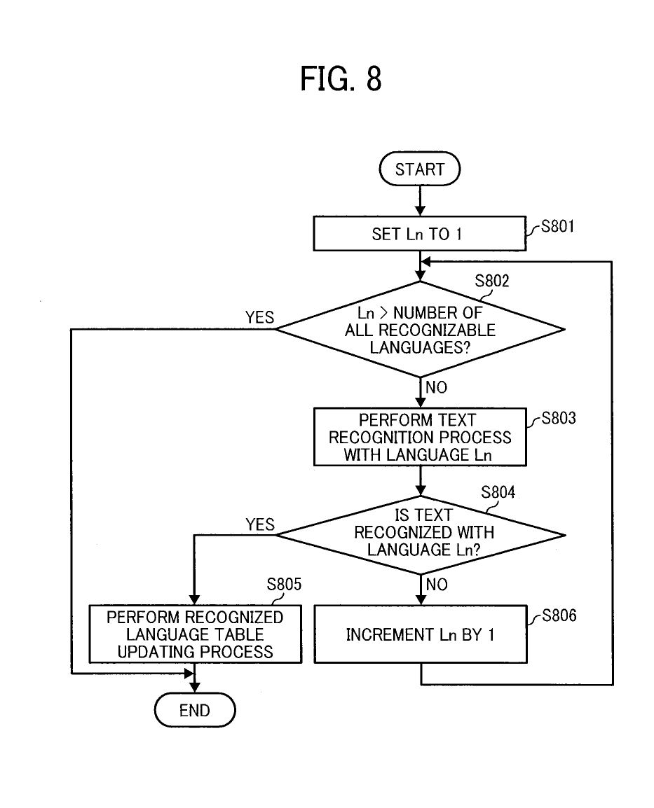

A detailed description will now be given of the language recognition process at step S703 of FIG. 7 performed on each text region extracted as a block. FIG. 8 is a flowchart illustrating an example of the procedure of the language recognition process at step S703 performed on each text region extracted as a block. In the procedure illustrated in FIG. 8, the value Ln indicating a recognizable language is first set to 1 (step S801). Then, if the value Ln exceeds the number of all recognizable languages, i.e., the number stored in the data region 203 for the number of language data items (YES at step S802), the language recognition process on the block is completed. If the value Ln is equal to or smaller than the number of all recognizable languages, i.e., the number stored in the data region 203 for the number of language data items (NO at step S802), a text recognition process is performed on the block with the language corresponding to the language data item Ln (step S803). Then, if the text is recognized with the language corresponding to the language data item Ln (YES at step S804), the language corresponding to the language data item Ln, in which the text is recognized, is registered in the recognized language table as a recognized language to update the recognized language table (step S805), and the language recognition process is completed. If the text is not recognized with the language corresponding to the language data item Ln (NO at step S804), the value Ln is incremented by 1 to perform the text recognition process on the block with the next language, i.e., a language following the language corresponding to the language data item Ln (step S806). These steps are repeated until the language recognition process is performed with all of the languages.

That is, in FIG. 8, the text recognition process on the block (step S803) is performed with the respective languages, starting from the language corresponding to the language data item 1 in the data region 204, which is registered as a language in which the OSD unit 105 is capable of displaying the text information. Then, if the text is recognized with a given language, i.e., the language corresponding to the language data item Ln (YES at step S804), the language in which the text is recognized is registered to update the recognized language table (step S805), and the language recognition process is completed.

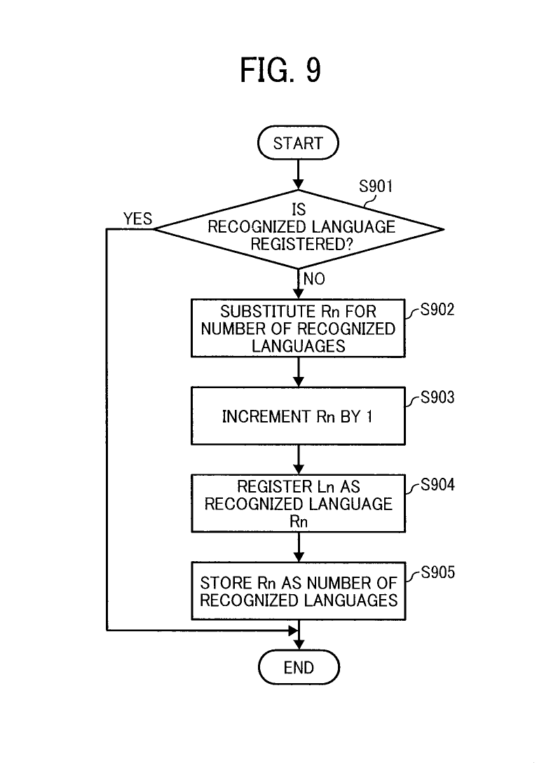

The recognized language table updating process at step S805 of FIG. 8 will now be described in detail. FIG. 9 is a flowchart illustrating an example of the procedure of the recognized language table updating process (step S805). In the recognized language table updating process, the language recognized in the block is registered in the recognized language table. In FIG. 9, if the recognized language has already been registered in the recognized language table (YES at step S901), the registration of the recognized language is not performed. If the recognized language has not been registered in the recognized language table (NO at step S901), the value Rn indicating the registration position of the recognized language corresponding to the language data item Ln is calculated. The value Rn is substituted for the value in the data region 301 for the number of recognized languages (step S902), and is incremented by 1 (step S903). Then, the language identification information of the language corresponding to the language data item Ln is registered in the data region 303 for the recognized language Rn (step S904), and the value Rn is stored in the data region 301 for the number of recognized languages (step S905). The value in the data region 301 for the number of recognized languages is thus updated.

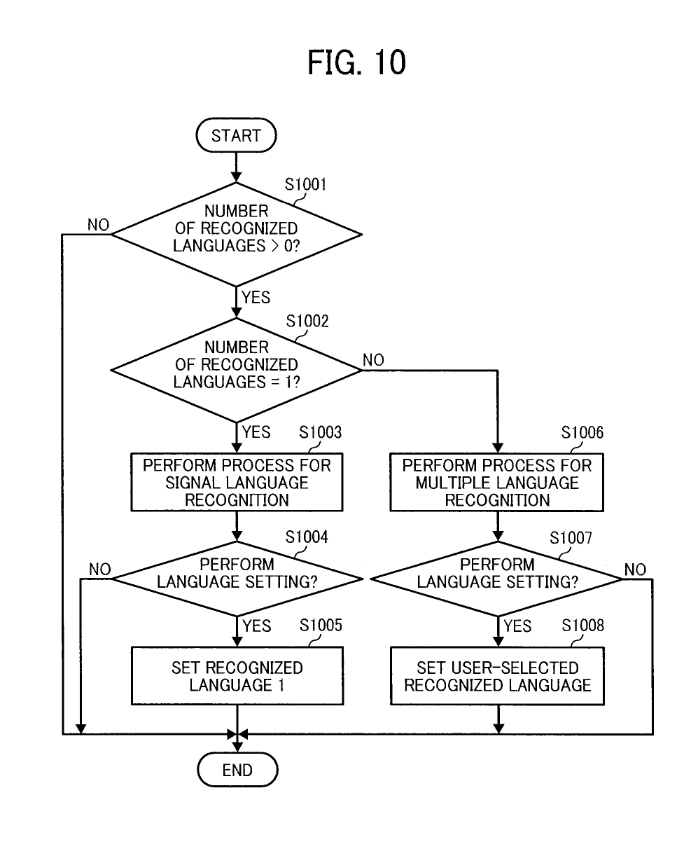

The recognized language setting at step S604 of FIG. 6 will now be described in detail. FIG. 10 is a flowchart illustrating an example of the procedure of the recognized language setting (step S604). In FIG. 10, if a language is recognized in the language recognition image, i.e., if the number of recognized languages in the data region 301 exceeds 0 (YES at step S1001), the recognized language is set as a display language in which the OSD unit 105 displays the text information. If the number of recognized languages is two or more (NO at step S1002), a process for multiple language recognition is performed which includes a process of selection of the display language by the user (step S1006). If the number of recognized languages is one (YES at step S1002), the selection of the display language by the user is unnecessary. Therefore, a process for signal language recognition not including the selection of the display language by the user is performed (step S1003). The process following the language recognition thus varies depending on whether the number of recognized languages is one or more.

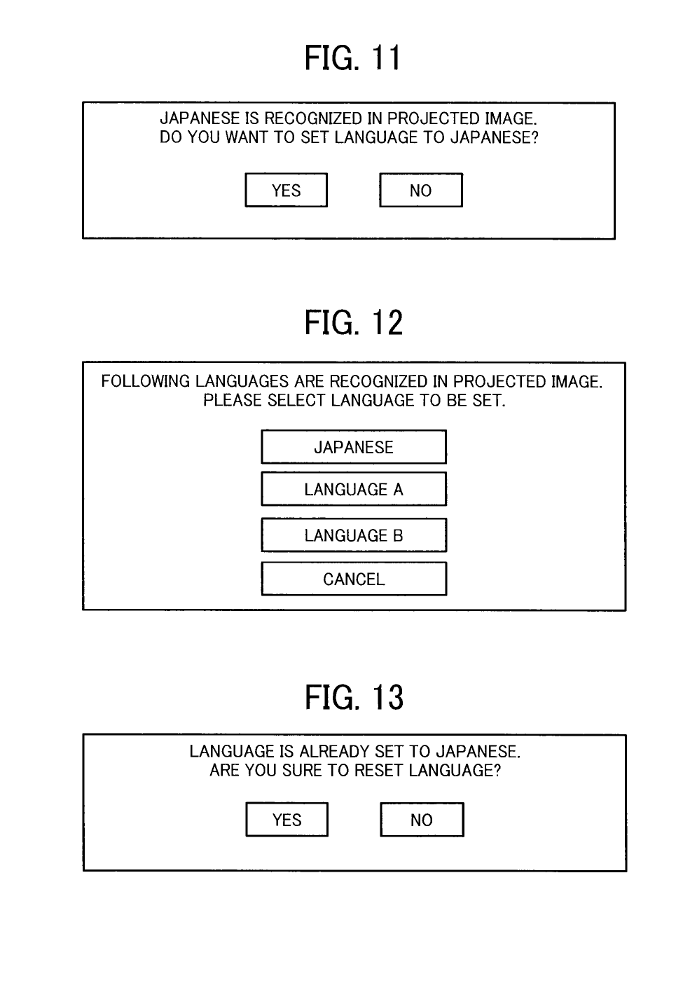

More specifically, if the number of recognized languages is one (YES at step S1002), the message illustrated in FIG. 11, for example, is displayed (step S1003). Then, if the user selects YES in the message (YES at step S1004), the value of the language identification information registered in the data region 302 for the recognized language 1 is set in the data region 202 for the set language as the language of the text information displayed by the OSD unit 105 (step S1005). If the user selects NO in the message (NO at step S1004), the setting of the language in the data region 202 is not performed. If the number of recognized languages is two or more (NO at step S1002), the message illustrated in FIG. 12, for example, is displayed (step S1006). FIG. 12 illustrates an example of the message displayed if the value in the data region 301 for the number of recognized languages is 3, and if Japanese, Language A, and Language B are registered as recognized languages in the data region 302 for the recognized language 1, a data region for a recognized language 2, and a data region for a recognized language 3, respectively. The user selects one of the three languages (YES at step S1007), and the selected language is set in the data region 202 for the set language as the language of the text information displayed by the OSD unit 105 (step S1008). If the user selects CANCEL in the message (NO at step S1007), the setting of the language is not performed.

FIG. 11 is a diagram illustrating an example of the message displayed at step S1003 of FIG. 10 if the number of recognized languages is one, i.e., if the value in the data region 301 for the number of recognized languages is 1, and if the recognized language is Japanese. In the example of FIG. 11, Japanese is the default language used to display the message. That is, the message illustrated in the drawing is an English translation of the original message displayed in Japanese. It is assumed that a display character string group written in Japanese is stored in a data region for a language data item Lx. In this case, a value Lx is stored in the data region 201 for the default language, and a value 1 is stored in the data region 301 for the number of recognized languages in the recognized language table. Further, the value Lx is stored in the data region 302 for the recognized language 1. If the user selects YES in the message, the value Lx indicating Japanese is set in the data region 202 for the set language as the language identification information.

FIG. 12 is a diagram illustrating an example of the message displayed at step S1006 of FIG. 10 if the number of recognized languages is three, i.e., if the value in the data region 301 for the number of recognized languages is 3, and if the recognized languages are Japanese, Language A, and Language B. In the example of FIG. 12, Japanese is the default language used to display the message. That is, the message illustrated in the drawing is an English translation of the original message displayed in Japanese. It is assumed that a display character string group written in Japanese is stored in a data region for a language data item Lx, a display character string group written in Language A is stored in a data region for a language data item Ly, and a display character string group written in Language B is stored in a data region for a language data item Lz. In this case, the value Lx is stored in the data region 201 for the default language, and a value 3 is stored in the data region 301 for the number of recognized languages in the recognized language table. Further, a value Lx is stored in the data region 302 for the recognized language 1, and a value Ly is stored in the data region for the recognized language 2. Furthermore, a value Lz is stored in the data region for the recognized language 3. If the user selects JAPANESE in the message, the value Lx indicating Japanese is set in the data region 202 for the set language as the language identification information.

FIG. 13 is a diagram illustrating an example of the message displayed at step S503 of FIG. 5 if a language has already been set as the language of the text information displayed by the OSD unit 105 when the user attempts to forcibly change the display language. In the example of FIG. 13, Japanese is the default language used to display the message. That is, the message illustrated in the drawing is an English translation of the original message displayed in Japanese. If the user selects YES in the message, the initial value (e.g., −1) is set in the data region 202 for the set language as the language identification information.

In the present embodiment, a description has been given of an image projection apparatus (i.e., projector) that projects and displays an image on an external projection screen serving as a display screen. The present invention, however, is also applicable to an image display apparatus other than the image projection apparatus (i.e., projector). For example, the present invention is also applicable to an image display apparatus that displays an image on a display screen such as a liquid crystal display or a cathode-ray tube (CRT) display, and exhibits similar effects.

According to the above-described embodiment of the present invention, an image display apparatus (i.e., the image projection apparatus 100) includes an image display device (i.e., the image signal processor 103, the projection image storage unit 104, the light source controller 106, the optical modulator 107, and the projection optical unit 108) configured to display an image on a display screen, a language recognition device (i.e., the language recognition image storage unit 113, the language recognition processor 114, the language data storage unit 115, and the recognition result storage unit 116) configured to recognize, on the basis of an image signal (i.e., image data) of an input image displayed on the display screen, the language of a text portion included in the input image, and a text information display device (i.e., the OSD unit 105) configured to display text information (i.e., menu or message) on the display screen using the language recognized by the language recognition device. According to this configuration, the language of the text information displayed on the display screen is recognized on the basis of the image signal of the input image including text that is likely to use a language comprehensible to a user. Therefore, the text information is displayed in a language that is likely to be understood by the user. Accordingly, the display of the text information in a language comprehensible to the user is reliably performed.

In the image display apparatus, the language recognition device performs the language recognition based on the image signal unless the language of the text information displayed by the text information display device is already set. According to this configuration, the language recognition by the language recognition device is limited to the situation in which the language of the text information displayed by the text information display device is not set. Therefore, the language recognition is not constantly performed, and thus the load of the language recognition process on the image display apparatus is reduced.

The image display apparatus further includes an operation device (i.e., the operation unit 110 and the remote control device 111) configured to receive an instruction. Further, if the operation device receives an instruction to recognize the language, the language recognition device performs the language recognition based on the image signal. According to this configuration, if there is a change in use environment, such as a change of user from a Japanese to an American, for example, it is possible to reset the language of the text information displayed by the text information display device and thereby promptly respond to the change of user or the like.

In the image display apparatus, if there is no language recognized by the language recognition device, the text information display device displays the text information using a preset predetermined language. According to this configuration, even if no language is recognized in the text when the language of the text information displayed by the text information display device is not set, the text information is displayed in a specific language (i.e., default language). Accordingly, it is still possible to use the image display apparatus to display the text information.

The above-described embodiments and effects thereof are illustrative only and do not limit the present invention. Thus, numerous additional modifications and variations are possible in light of the above teachings. For example, elements or features of different illustrative embodiments herein may be combined with or substituted for each other within the scope of this disclosure and the appended claims. Further, features of components of the embodiments, such as number, position, and shape, are not limited to those of the disclosed embodiments and thus may be set as preferred. It is therefore to be understood that, within the scope of the appended claims, the disclosure of the present invention may be practiced otherwise than as specifically described herein.

What is claimed is:

1. An image display apparatus comprising:
an image display device configured to display an image on a display screen;
a language recognition device configured to recognize, on the basis of an image signal of an input image displayed on the display screen, the language of a text portion included in the input image; and
a text information display device configured to display text information on the display screen using the language recognized by the language recognition device.

2. The image display apparatus according to claim 1, wherein the language recognition device performs the language recognition based on the image signal unless the language of the text information displayed by the text information display device is already set.

3. The image display apparatus according to claim 1, further comprising:
an operation device configured to receive an instruction,
wherein, if the operation device receives an instruction to recognize the language, the language recognition device performs the language recognition based on the image signal.

4. The image display apparatus according to claim 1, wherein, if there is no language recognized by the language recognition device, the text information display device displays the text information using a preset predetermined language.

5. The image display apparatus according to claim 2, wherein, if there is no language recognized by the language recognition device, the text information display device displays the text information using a preset predetermined language.

6. The image display apparatus according to claim 3, wherein, if there is no language recognized by the language recognition device, the text information display device displays the text information using a preset predetermined language.
